(19) United States
(12) Patent Application Publication
(10) Pub. No.: US 2018/0053200 A1
(43) Pub. Date: Feb. 22, 2018

(54) INCENTIVIZING SHARING OF WEARABLE TECHNOLOGY SENSOR DATA

(71) Applicant: KONINKLIJKE PHILIPS N.V., EINDHOVEN (NL)

(72) Inventors: John Cronin, Bonita Springs, FL (US); Seth Melvin Cronin, Essex Junction, VT (US)

(21) Appl. No.: 15/550,436

(22) PCT Filed: Mar. 8, 2016
(86) PCT No.: PCT/EP2016/054835

§ 371 Date: Aug. 11, 2017

Related U.S. Application Data
(60) Provisional application No. 62/130,140, filed on Mar. 9, 2015.

(30) Foreign Application Priority Data
Jul. 20, 2015 (EP) 15177461.9

(51) Int. Cl. G06Q 30/02; G06F 19/00; G06F 1/16

(52) U.S. Cl. CPC G06Q 30/0208; G06Q 30/0239; G06F 19/322; G06Q 50/22; G06F 19/3481; G06F 1/163; G06F 19/345; G06F 19/3418

(57) ABSTRACT

Disclosed herein are systems, wearable devices, computing devices, and methods for providing an incentive, such as a token, data analytics, redeemable points, etc., to a user in exchange for the user providing personal health parameter data collected by a wearable technology device worn by the user. In some embodiments, one or more user interfaces that allow the user to select the type(s) of data to be shared in exchange for incentives, and that allow the user to set various flags to control security and/or handling of the data, may be provided.

### RELATED APPLICATION DATA

This application claims the benefit of priority of U.S. Provisional Patent Application Ser. No. 62/130,140, filed on Mar. 9, 2015, and titled “Methods and Software for Providing an Incentive to a User in Exchange for Sharing Wearable Technology Sensor Data,” which is incorporated by reference herein in its entirety for all purposes.

### TECHNICAL FIELD

The present disclosure generally relates to the field of health monitoring. In particular, but not exclusively, the present disclosure is directed to methods and apparatus for providing an incentive to a user in exchange for sharing wearable technology sensor data.

### BACKGROUND

Throughout the last decade, propitious effects of Moore's law and related developments have led to many advances in computing technology. Wearable technology has not been overlooked in this progression. Developers continue to research and implement various augmented reality applications, advanced pedometers, and exercise monitoring devices, among others, in an attempt to identify a confluence between cutting-edge technology and consumer demand. However, wearable technology has yet to be widely established in the marketplace and many new and improved technologies and techniques need to be developed in order to produce useful and convenient wearable technology that consumers will embrace.

### SUMMARY

In one implementation, the present disclosure is directed to a method of providing an incentive to a user of a wearable device. The method may include providing, by one or more processors of a wearable device worn by a user, a user interface operable by the user; receiving, at the user interface, a data sharing setting for a health parameter type detected by one or more sensors operably coupled with the one or more processors; transmitting, by the one or more processors over one or more communication links, to one or more remote computing devices accessible by a third party data user pursuant to said data sharing setting, personal health parameter data of said health parameter type detected by the one or more sensors; receiving, by the one or more processors over the one or more communication links, in exchange for the shared personal health parameter data, data indicative of an incentive; and outputting, by the one or more processors using an output device, a representation of the incentive to the user.

In another implementation, the present disclosure is directed to a computing device that includes a processor and memory, and a plurality of computer instructions stored in the memory which when executed by the processor cause the computing device to perform the following operations for sharing personal health parameter data detected by one or more sensors of a wearable device in exchange for an offered incentive: storing, in the memory, the personal health parameter data detected by one or more sensors of the wearable device; receiving an offer from an identified data user that requests personal health parameter data in exchange for an incentive; receiving one or more data user settings indicating data users authorized to receive the personal health parameter data; receiving one or more incentive settings indicating incentives that a user will accept to share the personal health parameter data; storing, in the memory, said data user settings and said incentive settings in association with the personal health parameter data to which they pertain; comparing said data user to said stored data user settings, and comparing said offered incentive to said stored incentive settings, for the personal health parameter data to which such offer pertains; and selectively transmitting the requested personal health parameter data to said data user based on a result of the comparing.

In yet another implementation, the present disclosure is directed to a wearable device, that includes at least one sensor for detecting, from a user wearing the wearable device, personal health parameter data of at least one health parameter type; one or more processors; and a memory operably coupled with the one or more processors. The memory may store a plurality of computer instructions which when executed by the one or more processors, cause the one or more processors to carry out the following operations for sharing said personal health parameter data: storing, in said memory, said personal health parameter data detected by said sensor, providing a user interface operable by the user; receiving, at the user interface, one or more data user settings identifying one or more data users authorized to receive said personal health parameter data, receiving, at the user interface, one or more incentive settings indicating one or more incentives that the user will accept in exchange for sharing said personal health parameter data, storing, in said memory, said data user settings and said incentive settings in association with said personal health parameter data to which they pertain, and comparing a requesting data user to said stored data user settings, and an offered incentive to said stored incentive settings, for requested personal health parameter data. The computing device may also include a communications transceiver operably coupled with the one or more processors to selectively transmit said requested personal health parameter data to said requesting data user based on a result of the comparing.

### BRIEF DESCRIPTION OF THE DRAWINGS

For purposes of illustration, the drawings show aspects of one or more embodiments of the disclosure. However, it should be understood that the present disclosure is not limited to the precise arrangements and instrumentalities shown in the drawings, wherein:

FIG. 1 is a flow diagram of an exemplary method of providing a user with an incentive in exchange for personal health parameter data;

FIG. 2 is a schematic diagram of an exemplary health parameter incentive exchange system for carrying out the method of FIG. 1;

FIG. 3 illustrates an exemplary personal health parameter data usage graphical user interface (“GUI”) that may be provided by base software 224 running, for example, on wearable device 202 of FIG. 2;

FIG. 4 illustrates an exemplary rules GUI that may be provided by base software 224 running, for example, on wearable device 202 of FIG. 2;

FIG. 5 illustrates an exemplary flag data GUI that may be provided by base software 224 running, for example, on wearable device 202 of FIG. 2;

FIG. 6 is a is an exemplary system block diagram of a wearable device usable with the health parameter incentive exchange system of FIG. 2;

FIG. 7 illustrates an exemplary data analysis GUI that may be provided by base software 224 running, for example, on wearable device 202 of FIG. 2;

FIG. 8 illustrates an exemplary data exchange GUI that may be provided by base software 224 running, for example, on wearable device 202 of FIG. 2;

FIG. 9 is a flow diagram illustrating an exemplary method that can be performed by base software 224 running, for example, on wearable device 202 of FIG. 2;

FIG. 10A contains a flow diagram illustrating an exemplary method that can be performed by data exchange software 226 running, for example, on wearable device 202 of FIG. 2;

FIGS. 10B and 10C contain a flow diagram illustrating an exemplary method that can be performed by data flagging software 228 running, for example, on wearable device 202 of FIG. 2;

FIG. 11 is a flow diagram illustrating an exemplary method that can be performed by token software 242 running, for example, on data exchange network 206 of FIG. 2;

FIG. 12 is a flow diagram illustrating an exemplary method that can be performed by data analysis software 244 running, for example, on data exchange network 206 of FIG. 2;

FIG. 13 is an exemplary overall method of providing an incentive to a user in exchange for sharing wearable technology sensor data; and

FIG. 14 is a high-level schematic diagram of a computing system that can be used to implement any one or more of the methodologies of the present disclosure.

### DETAILED DESCRIPTION

Aspects of the present disclosure are directed to providing incentives, such as tokens, data analytics, and reward points, among others, to users in exchange for personal health parameter data collected by wearable technology devices, for example, smartwatches, health-bands, and fitness-bands, among others. Examples of “personal health parameter data” that can be detected, or measured, using a wearable technology device include vital signs (e.g., temperature, pulse, respiratory rate, blood pressure), heartbeat, physical activity, perspiration, heart sounds, lung breathing sounds, and other audio, including speech recognition, among others. As described below in more detail, such aspects can be facilitated by various graphical user interfaces (“GUIs”) and other software features running on one or more of a variety of devices, including wearable technology devices as described above (or simply “wearable devices”), personal computing devices such as smartphones, tablet computers, and the like (or simply “user devices”), and web servers, among other devices. These broad aspects of the present disclosure and their facilitating components are described below in connection with a variety of examples.

Conventional wearable devices are largely unsecure as compared to most smart devices. Currently, wearable devices maintain security primarily by preventing transmission of any acquired personal health parameter data. For example, most conventional fitness bands collect personal health parameter data and conduct computational analysis on a fitness band itself, and then provide a set of fitness-based displays to a user. To the extent wearable devices transmit personal health parameter data for analysis by a remote computing device, data is typically transmitted to remote devices specifically associated with the provider of the wearable device in question, as opposed to making such data available more broadly to third party data users. Such “data users” include, by way of example and not limitation, doctors authorized to receive patient's personal health parameter data remotely, gym networks authorized to receive customer's personal health parameter data while on site as well as other providers of on-site health related services such as rehabilitation services, senior living communities, hospitals, and nursing homes, restaurants and other providers of services not directly related to health related services, and “big data” users who compile information to discern trends that they share with their customers. Such data users generally have no way of incenting wearable device users to share their personal health parameter data, and are thus unable to acquire large amounts of wearable data from many users. Consequently, one aspect of the present disclosure is to create a data exchange network that allows a wearable device user to receive one or more incentives from data users in exchange for their wearable data.

By way of example and not limitation, an “incentive” may include one or more of a token (for example, a discount on an item, or an offer of a free item), rewards points for, e.g., a credit card, a payment, a software application (commonly, an “app”) made available for free or at discounted cost to a user device associated with a user, an offer to provide an analysis on personal health parameter data shared with a data user. Other examples of an “incentive” include motivational tools such as supporting messages or other encouragement based on shared personal health parameter data, or a description of objectives of a data user in collecting such information, e.g., to assist with an ongoing university health study. “Incentives” may further include a grant of additional data storage or data usage capacity to an associated user device (or other user devices), or any other sort of information or item that would serve to incent a user to share personal health parameter data. GUIs and software allow a user to set rules (“data sharing settings”) for different types of health data (“health parameter types”). Health parameter types may include activity data, specific types of health related measurements (such as heart rate, temperature, blood pressure, and the like), and other personal health parameter data (such as audio). Data sharing settings include one or more of “data user settings” that specify one or more of potential data users with which personal health parameter data may be shared, “incentive settings” that specify types of incentives that may be offered to encourage a user to share personal health parameter data, and “security settings” (or “flags”) that specify data retention, data anonymity, encryption, and other data security to be applied to personal health parameter data when shared with a data user.

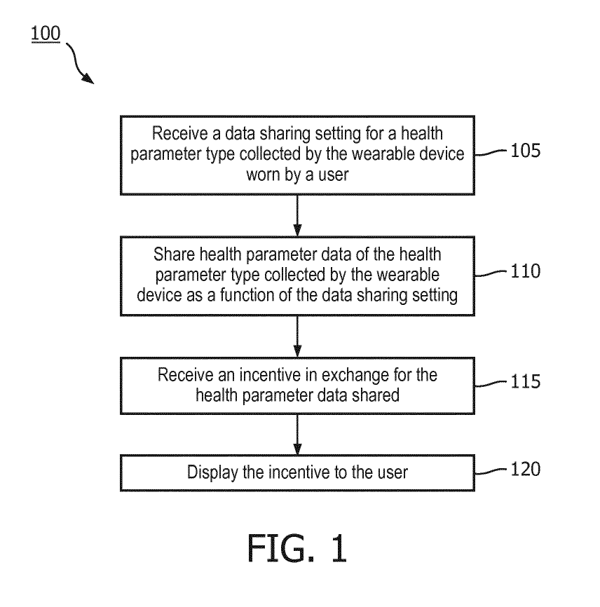

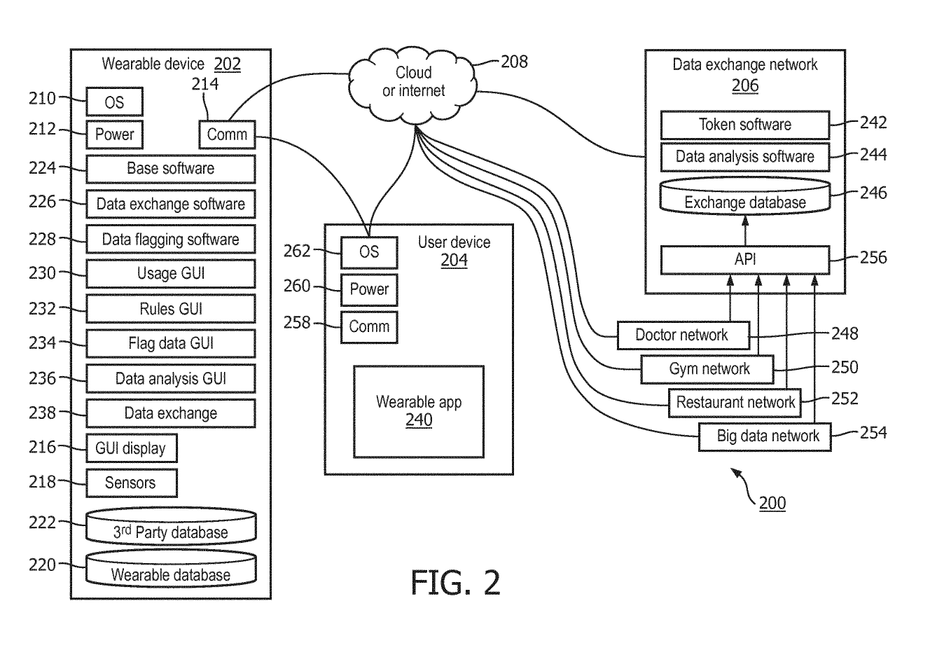

FIG. 1 illustrates an exemplary high-level method 100 that can be performed by data exchange software executed on one or more devices of a data exchange system, such as the exemplary data exchange system of FIG. 2. Before describing the method of FIG. 1, the data exchange system of FIG. 2 is first described to give the reader an exemplary context in which such method may be executed. Referring now to FIG. 2, data exchange system 200 illustrated includes three primary components, namely, wearable device 202, user device 204, and data exchange network 206. These three primary components may communicate with one another directly and/or over one or more communications networks, here, designated by cloud or Internet 208 (though it will be appreciated that other networks such as LANs and carrier networks may for part or all of the communications network 208), using well-known communications protocols including, by way of example and not limitation, GSM, GPRS, EDGE networking, Wi-Fi® or WiMax® (registered trademarks of the WiFi Alliance), and BLUETOOTH® (registered trademark of Bluetooth SIG, Inc.). Each of these components and pertinent parts thereof is described below in enough detail to allow those skilled in the art to make and use the present disclosure.

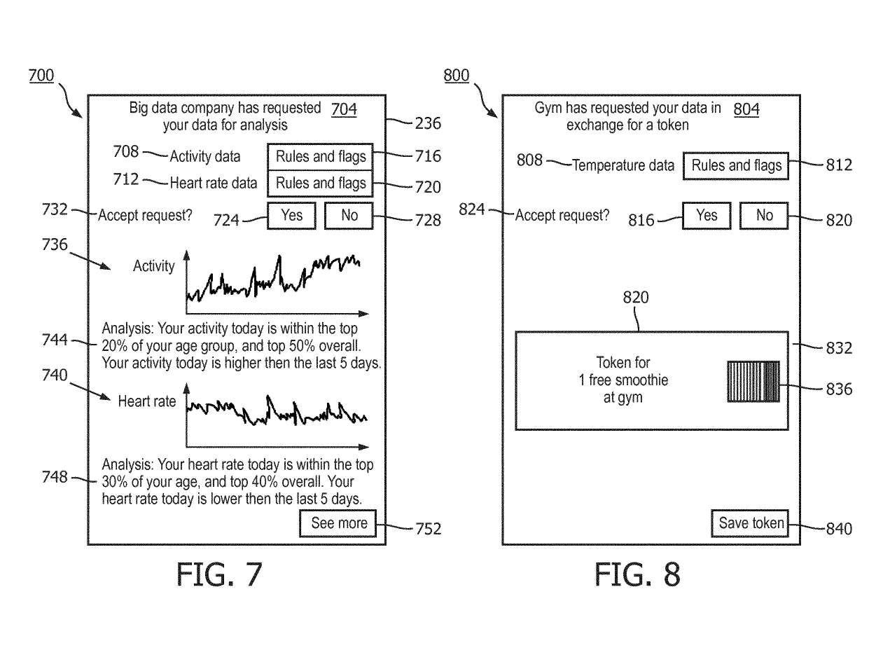

In the embodiment shown, wearable device 202 includes operating system (OS) 210, power source 212, such as a battery, communications transceiver 214 (comm) for enabling direct and indirect communications with user device 204 and/or data exchange network 206 as described above, one or more displays 216, one or more health-parameter sensors 218, a wearable database 220, and a third party database 222. OS 210, examples of which are described below with reference to FIG. 6, may be any suitable operating system for controlling the overall functioning of wearable device 202. Communications transceiver 214 includes an RF antenna (not shown) or other device that enables wireless transmission and reception of data, such as an IR transceiver, as well as associated hardware and software, that support any one or more wireless communications protocols for providing communications with user device 204, data exchange network 206, and/or other device(s), directly and/or via cloud or Internet 208, including but not limited to the examples listed above, among others. Fundamentally, there is no limitation on what type of wireless communications protocol(s) may be utilized by communications transceiver 214, as long as the selected protocol(s) enables wireless communication of the various signals described below. Each display 216 may be any suitable type of display, such as a graphical display based on liquid crystal technology, light-emitting-diode technology, electronic paper technology, audio technology, or haptic technology, among others, and any combination thereof. Each sensor 218 can be any suitable sensor for obtaining readings of one or more health parameter types as described above, such as a microphone, a contact thermometer, an optical thermometer, a pressure sensor, and a moisture sensor, among others. Wearable database 220 stores personal health parameter data as generally described above, such as raw data acquired using sensor(s) 218 and/or processed versions of the raw data, and may include other data related thereto, such as date/time when such raw and/or processed data was obtained, and data sharing settings pertaining thereto (described in more detail below), among other things. Third-party database 222 stores information about third party data users, such as their identity, offered incentives, information related to data users' respective networks, and other information relating to data users as described in more detail below. It is to be understood that wearable database 220 and third-party database 222 may be relational database products, or data management software for controlling storage of data on conventional device storage such as described in more detail below with reference to FIG. 6, which depicts an exemplary system architecture of wearable device 202.

Wearable device 202 also includes various software modules that control the operation of various functionality of the wearable device, and provide various GUIs via one or more displays that allow a user to interact with the software and make various selections and/or other inputs that control data exchange functionality of such data exchange system. In this example, wearable device 202 includes base software 224, data exchange software 226, and data flagging software 228, and provides a usage GUI 230 under control of and in communication with base software 224, a rules GUI 232 under control of and in communication with base software 224, a flag data GUI 234 under control of and in communication with base software 224, a data analysis GUI 236 under control of and in communication with base software 224, and a data exchange GUI 238 under control of and in communication with base software 224. Each of these features is described briefly herein, with detailed examples being presented below in conjunction with various figures. The foregoing software modules, as well as other software modules as described below, may be written in any software language that is compatible with any of the operating systems described below that are associated with computing devices on which such software is to be executed. Examples of such software languages include but are not limited to Java, C, C++, Pascal, Visual Basic, and Perl. In the description to follow, it is to be understood that while particular functions are described as being carried out by particular software modules, such functions may be combined in one or more larger modules of software code.

Base software 224 takes readings from sensors 218 and stores readings in wearable database 220, and initiates execution of other software and GUIs of the present disclosure such as (by way of example and not limitation) data exchange software 226, data flagging software 228, usage GUI 230, rules GUI 232, flag data GUI 234, data analysis GUI 236, and data exchange GUI 238. In some embodiments, base software 224 may also provide additional functionality, such as various manipulations and processing of raw data, as well as providing visualizations of raw data to a user, such as via display 216 or via a display on another device, such as user device 204 or other device (not shown) accessible via communications transceiver 214. Data exchange software 226 controls various operations of data exchange functionalities between users and data users, as will be described in more detail below. Data flagging software 228 allows a user to “package” personal health parameter data with one or more flags that can control usage of data outside of wearable device 202 and user device 204, such as by data user(s) that receive a user's personal health parameter data in exchange for one or more incentives. Examples of flags and flag-setting are described below.

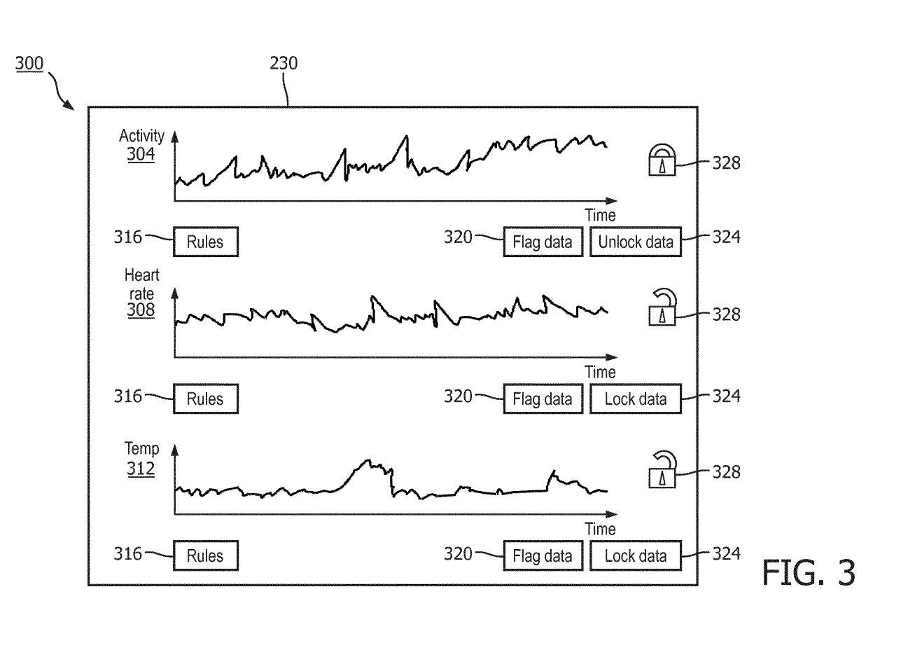

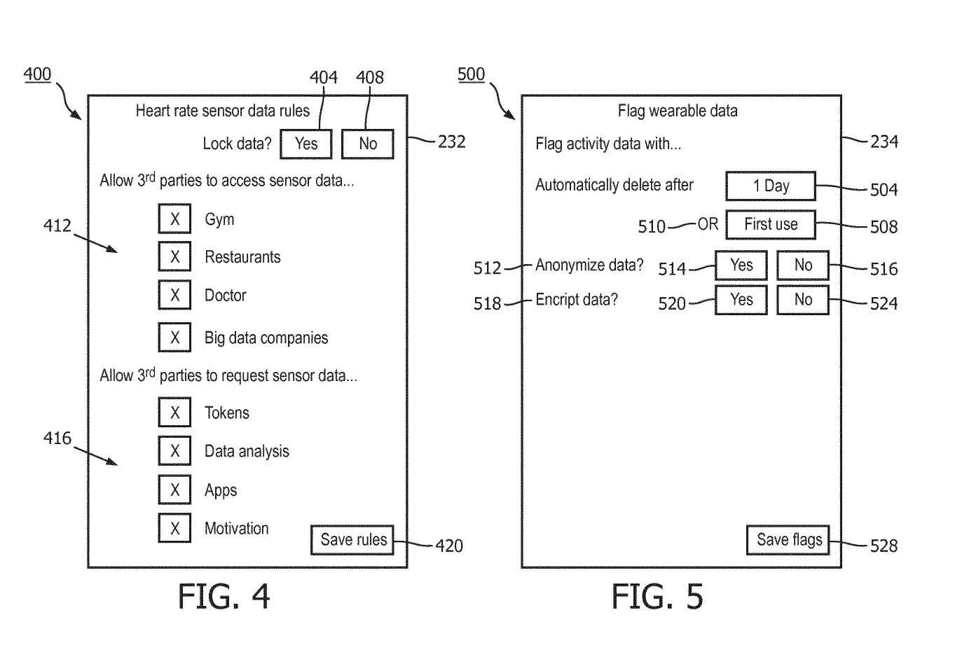

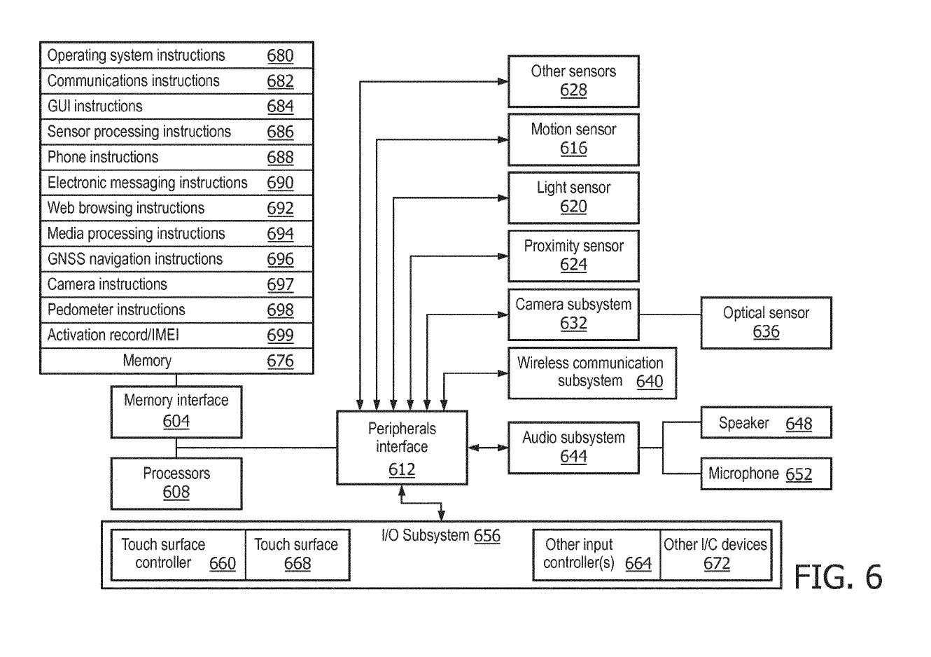

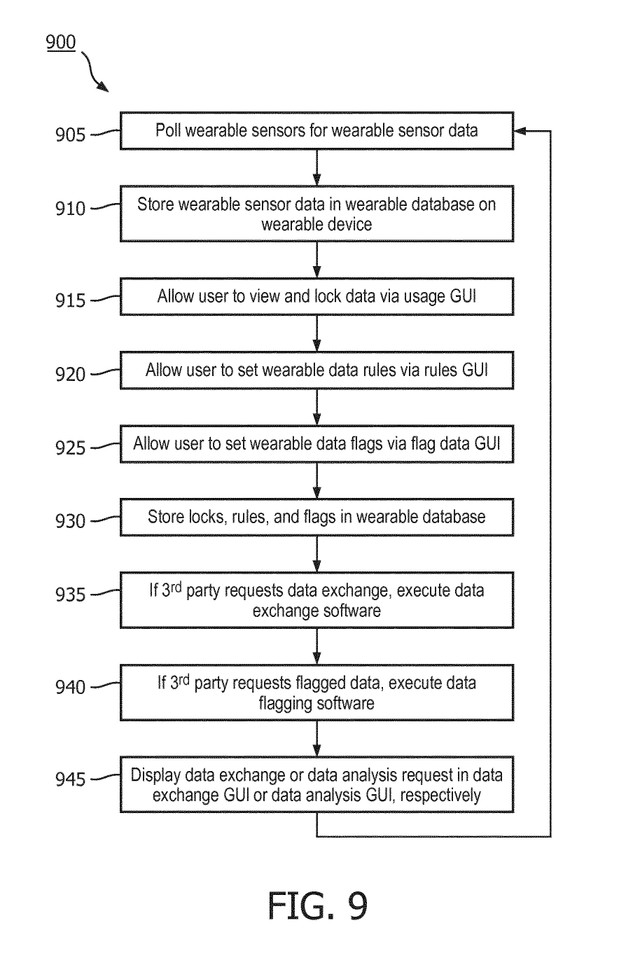

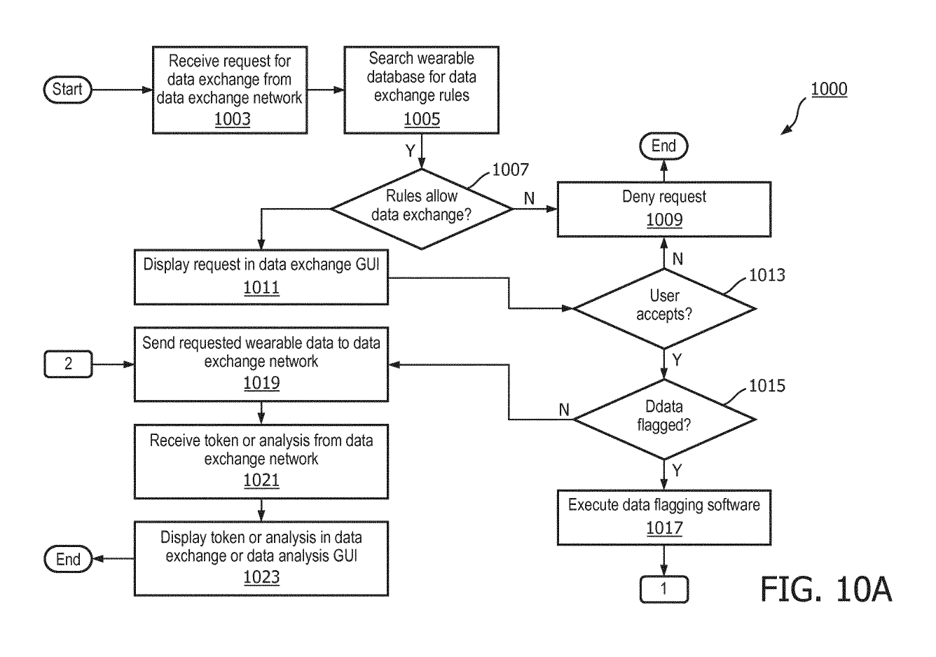

Usage GUI 230 provides a high-level interface that allows a user to control various data display and sharing settings, such as setting up data user settings and incentive settings (also collectively referred to as “rules”), setting up flags, and locking and unlocking data, all of which can be done by heath parameter type for maximum flexibility. The structure and operation of usage GUI 230 and associated control signals will be described in more detail below with reference to FIG. 3. Rules GUI 232 allows a user to set various rules that include data user settings that grant access permission by heath parameter type, and incentive settings that grant access permission by incentive type, among other things. The structure and operation of rules GUI 232 and associated control signals will be described in more detail below with reference to FIG. 4. Flag data GUI 234 allows a user to set various data sharing settings pertaining to security settings, such as an auto-deletion flag, a data-anonymize flag, and a data-encryption flag, among others. The structure and operation of flag data GUI 234 and associated control signals will be described in more detail below with reference to FIG. 5. Data analysis GUI 236 allows a user to accept a data-usage request from a third party that is based on the incentive of providing data analysis in exchange for a user's data. Such data analyses are based on generally available statistical and graphical analysis tools, and in alternate embodiments may include comparisons of a user's data to similar data from other users or to previous data from a user, or other comparative analyses. The structure and operation of data analysis GUI 236 and associated control signals will be described in more detail below with reference to FIG. 7. Similarly, data exchange GUI 238 allows a user to accept a data-usage request from a third party that is based on an incentive being of a particular type (such as a token, rewards points, or other financial incentive). The structure and operation of data exchange GUI 238 and associated control signals will be described in more detail below with reference to FIG. 8. Information concerning the exchange of data, such as data-analysis information and data-exchange information received, respectively, via data analysis GUI 236 and data exchange GUI 238 may also be stored in third-party database 222 aboard wearable device 202.

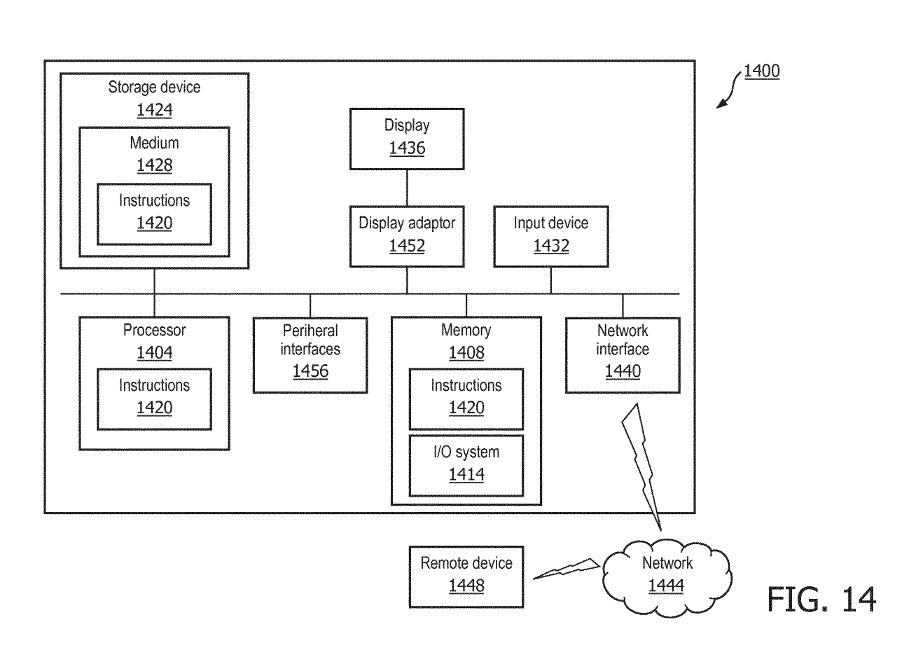

User device 204 may be any suitable user device personal to a user, such as a smartphone, tablet computer, desktop computer, cloud computing device, etc., that includes power source 258, operating system 260, and communications transceiver 262, among other things. A more detailed example of an overall architecture for user device 204 is described below with reference to FIG. 14. Power source 258 may be any suitable power source, such as a battery or line-powered power source. Operating system 260 may be any operating system suitable to the device at issue, such as the iOS operating system, Mac OS operating system, Android operating system, WindowsPhone operating system, Windows operating system, Linux operating system, etc. Communications transceiver 262 may include an RF antenna and associated hardware and software as described above for communications transceiver 214, and may also support wireless protocols such as those described above as well as one or more wired protocols such as the Ethernet protocol, among many others. User device 204 may also include a wearable software application 240 that provides some or all of the data exchange functionality described above relative to wearable device 202, in a redundant or non-redundant manner In some embodiments, all of the data exchange functionality described above may reside only on wearable device 202. In other embodiments, all of the data exchange functionality described above may reside only on user device 204. In still other embodiments, some of the data exchange functionality described above (such as, solely by way of example, one or more of usage GUI 230, rules GUI 232, flag data GUI 234, data analysis GUI 236, and data exchange GUI 238) may exclusively reside on wearable device 202, while other parts of the data exchange functionality described above (such as, solely by way of example, one or more of base software 224, data exchange software 226, data flagging software 228, third-party database 222, and wearable database 220) may exclusively reside on user device 204. It is noted that user device 204 is shown partly because current wearable technology devices typically require interaction with a more robust computing device for programming, long-range data/voice communications, and/or data sourcing and manipulation, among other things. Future wearable devices, however, may not require such “tethering.” Accordingly, in alternate embodiments all of the functionality described with reference to user device 204 may be included in wearable device 202, and user device 204 may not be included at all.

Data exchange network 206 in this example is enabled by software running on a server, workstation, or other computer device as described in more detail below with reference to FIG. 14. Data exchange network 206 includes software capable of providing token incentives and data-analysis incentives (amongst other incentives, as described in more detail below) and correspondingly includes token software 242 and data analysis software 244 that serve-up to users tokens and data-analysis information, respectively, in exchange for users' personal health parameter data. In alternate embodiments, other types of incentive-handling software is provided for types of incentives other than tokens or data analysis, such as software that supports an incentive of providing to a user a free software app, among others. Data exchange network 206 also includes an exchange database 246, which may include, among other things, the incentives, rules for offering incentives, information about participating third parties, information about participating users, and parameters for analyzing user data, among other things. Those skilled in the art will readily appreciate that exchange database 246 can be populated by the appropriate parties, which include not only the user of wearable devices 202 and user devices 204, but also by data users including by way of example, doctors (via doctor network 248), gyms (via gym network 250), restaurants (via restaurant network 252), and big data users (via big data network 254), via cloud or Internet 208, using an appropriate application programming interface (API) 256 or other suitable user interface.

While the data exchange network 206 is described as being a “network,” it will be apparent that in some other embodiments, the data exchange “network” 206 may constitute a single device such as a server or virtual machine running in a cloud computing environment. Similarly, in some embodiments, one or more of the doctor network 248, gym network 250, restaurant network 252, and big data network 254 may constitute single devices, respectively.

With data exchange system 200 of FIG. 2 described above at a high level, reference is again made to FIG. 1, which shows a method 100 of sharing personal health parameter data collected by a wearable device worn by a user and that may be performed by data exchange software 226 of FIG. 2. As seen in FIG. 1, at step 105, data exchange software 226 receives a data sharing setting for personal health parameter data of a particular health parameter type (e.g., one or more of pulse, temperature, heartrate, and other personal health parameter data as described above) that is collected by one or more sensors 218 onboard wearable device 202. At step 110, data exchange software 226 shares personal health parameter data of the health parameter type collected by wearable device 202 with authorized data users, pursuant to a data sharing setting applicable to that particular personal health parameter data. At step 115, an incentive is received via data exchange software 226 in exchange for such personal health parameter data shared, and at step 120, data exchange software 226 displays a received incentive to a user. As those skilled in the art will readily appreciate from reading this entire disclosure, these steps will typically be performed, among many others, and can be performed by appropriate data exchange software 226 regardless of where it resides within data exchange system 200. With the high-level methodology of FIG. 1 briefly discussed, specific examples that will help the reader further understand various aspects of the present disclosure will now be described.

While not illustrated, it will be apparent that the various devices 202, 204, 206 in the example system 200 include hardware, such as one or more processors each, to carry out the functionalities described herein. As used herein, the term “processor” will be understood to encompass various hardware devices such as, for example, microprocessors, field-programmable gate arrays (FPGAs), application specific integrated circuits (ASICs), and other hardware devices capable of performing the various functions described herein as being performed by the wearable device 202, server 252, or other device. Additionally, the devices 202, 204, 206 may include memory devices (not shown) that store the various software, GUI instructions, and databases described herein. Such memory devices may include various devices such as L1/L2/L3 cache, system memory, or storage devices. As used herein, the term “non-transitory machine-readable storage medium” will be understood to refer to both volatile memory (e.g., SRAM and DRAM) and non-volatile memory (e.g., flash, magnetic, and optical memory) devices, but to exclude mere transitory signals. While various embodiments may be described herein with respect to software or instructions “performing” various functions, it will be understood that such functions will actually be performed by hardware devices such as a processor executing the software or instructions in question. In some embodiments, such as embodiments utilizing one or more ASICs, various functions described herein may be hardwired into the hardware operation; in such embodiments, the software or instructions corresponding to such functionality may be omitted.

FIG. 3 illustrates an exemplary screenshot 300 of usage GUI 230 of base software 224 of wearable device 202 of FIG. 2. Usage GUI 230 of FIG. 3 is presented in a high level form; in practice, usage GUI of FIG. 3 (as well as all other GUIs depicted in the various FIGURES of this disclosure) may include any one of a number of known graphical elements that enhance the aesthetic and functional aspects of such display, such as background colors, colored displays and icons, flashing displays and icons, pulldown or scrolldown menus, and the like. In FIG. 3, usage GUI 230 displays three health parameter types, Activity 304, Heart Rate 308, and Temp(erature) 312. It is to be understood that while particular health parameter types are displayed in FIG. 3, usage GUI 230 may display other, or additional, personal health parameter data of other health parameter types, such as, by way of example and not limitation, blood pressure, perspiration, heart sounds, lung breathing sounds, and other audio. Data collected by sensors 218 of wearable device 202 for each of the depicted health parameter types is represented by a corresponding graph of the parameter versus time. In alternate embodiments collected personal health parameter data may be displayed using other techniques, such as numbers, trending data, bar charts, and any one of a number of other known techniques for depicting or displaying data.

Accompanying each graph of FIG. 3 is a set of user controls, here a “Rules” soft button 316, a “Flag Data” soft button 320, and an “unlock Data”/“Lock Data” soft button 324, along with lock-status icon 328 that corresponds to a lock state of the corresponding data. A “soft button” is an area of a GUI that when selected by a user (such as by touch, pointing device such as an electronic pen or mouse, or otherwise) causes specified data to be displayed or a specified operation to occur. When a user selects any of “Rules” soft buttons 316, base software 224 causes device 202 to display rules GUI 232 (as will be described in more detail below with reference t FIG. 4). Similarly, when a user selects any of “Flag Data” soft buttons 320, base software 224 causes device 202 to display flag data GUI 234 (as will be described in more detail below with reference to FIG. 5). Each “unlock Data”/“Lock Data” soft button 324 allows a user to “lock” corresponding personal health parameter data to keep it from being accessed by any third party data user, regardless of any data sharing settings that would otherwise enable access via rules set in rules GUI 232, and to unlock such personal health parameter data so that it can be accessed by a third party data user pursuant to data sharing settings set in rules GUI 232. The corresponding lock-status icon 328 displays a locked state as controlled by “unlock Data”/“Lock Data” soft button 324, for easy viewing. In the example shown in FIG. 3, for Activity 304 data, “unlock Data”/“Lock Data” soft button 324 is set to “unlock Data,” and the corresponding icon indicates this data is not locked.

FIG. 4 illustrates an exemplary screenshot 400 of rules GUI 232 of base software 224 of device 202 of FIG. 2. In this screenshot, rules GUI 232 includes “Yes” and “No” soft buttons 404 and 408, respectively, that allow a user to lock and unlock collected data. This is redundant functionality to “unlock Data”/“Lock Data” soft button 324 described above relative to FIG. 3. Rules GUI 232 enables a user to set data sharing settings that include data user settings that indicate which third party(ies), or which type(s) of third party(ies), have permitted access to corresponding personal health parameter data of a given health parameter type. It is to be understood that while FIG. 4 depicts individual recipients “Gym,” “Restaurants,” “Doctor,” and “Big Data Company,” having corresponding respective soft button selectors 412 that may be individually activated, other recipients may be specified. In alternate embodiments recipients may be listed as groups of recipients sharing a common characteristic. Such a common characteristic may be type of business. By way of example and not limitation, such groups may be “Medical Providers” (which may be enabled as a group, and/or may list individual potential recipients or groups of recipients such as “Doctor,” “Hospital,” “Physical Therapy,” and the like); “Physical Activity Providers” (which may be enabled as a group, and/or may list individual potential recipients or groups of recipients such as “Gym,” “Mall Walking,” “Tennis Courts,” and the like); “Other Providers” (which may be enabled as a group, and/or may list individual potential recipients or groups of recipients such as “Restaurants,” “Stores,” “Grocery Stores,” and the like); and/or “Big Data Companies” (which may be enabled as a group, and/or may list individual potential recipients or groups of recipients). In alternate embodiments, such recipients may be specified by naming specific individuals. By way of example and not limitation, under the “Doctor” recipient setting, individual doctors “Dr. Smith,” “Dr. Jones,” may be individually specified, to either individually receive personal health parameter data, or as proxies for enabling access by their related health networks. For example, specifying “Dr. Smith” may allow access by a HMO, hospital, a practice group, or any other medical group or organization with which Dr. Smith is associated.

Rules GUI 232 also enables a user to specify data sharing settings pertaining to incentives, by establishing incentive settings that specify which incentive(s), or type(s) of incentive(s), a user is willing to accept in exchange for transmitting personal health parameter data of a given health parameter type. FIG. 4 depicts specific incentives such as “Tokens,” “Data Analysis,” “Apps,” and “Motivation,” as described above, having corresponding respective soft button selectors 416 that can be individually activated. Other incentives may be offered. In alternate embodiments incentives may be listed as groups of related incentives sharing a common characteristic. Such a common characteristic may be type of incentive. By way of example and not limitation, such groups may be “Financial Incentives” (which may be enabled as a group, and/or may list individual potential incentives or groups of incentives such as “Token,” “Payment,” “Reward Points,” and the like); “User Device Incentives” (which may be enabled as a group, and/or may list individual potential incentives or groups of incentives such as “App,” “Data Storage Upgrade,” “Smartphone Plan Upgrade” and the like); “Data Analysis Incentives” (which may be enabled as a group, and/or may list individual potential incentives or groups of incentives such as specific types of data analysis), and/or “Motivational Incentives” (which may be enabled as a group, and/or may list individual potential incentives or groups of incentives such as indicating health advantages to a user that may result from improvements to the shared personal health parameter data, or describing general societal benefits or objectives of a data user in collecting such information such as contributing to an important ongoing health study).

In alternate embodiments, one or both of the foregoing options for enabling potential data users, and potential incentives, may be specified by health parameter type. By way of example and not limitation, in such embodiments rules GUI 232 includes a separate list of options and settings as described above for each health parameter type, such as one for activity data, one or more for specific types of health related measurements (such as heart rate, temperature, blood pressure, and the like), and one or more for other health related data (such as audio). As shown in FIG. 4, the foregoing options for data user settings and incentive settings are set forth for “Heart Rate Sensor Data.” Rules GUI 232 also includes a “Save Rules” soft button 420 that allows a user to save these data sharing settings in wearable database 220 such that, for each health parameter type, such settings are stored in the same relational table rows as (or in other association with) corresponding personal health parameter data to which they pertain. Button 240 also closes rules GUI 232.

FIG. 5 illustrates an exemplary screenshot 500 of flag data GUI 234 of base software 224 of wearable device 202 of FIG. 2. In this screenshot, flag data GUI 234 includes various soft buttons that allow a user to set data sharing settings pertaining to security settings such as automated deletion, anonymizing data, and encrypting data. As shown in FIG. 5, a user has an option to set such flags for different health parameter types, such as “Activity Data” as shown. In alternate embodiments such flags may be set as a function of the identity or type of data user to access such data. “Automatic deletion” soft button 504 allows a user to specify how long data is to be retained after it is transferred to a data user. This option may be presented in the form of a pulldown menu or as an option for text entry. A user may select a timer option, such as “1 Day,” such that data is deleted (or disabled) one day after it is transmitted to a data user. In alternate embodiments, this timer option may commence upon initial storing of such data on wearable device 202, and would not be dependent on when data is transferred to a data user. In alternate embodiments, this data deletion option may also include an additional, alternate option, such as “First Use” soft button 508, as shown, by which data is deleted once information is entered into an access log included in or associated with data when transmitted, indicating such data user has accessed such data post-transmission. In this specific example, these two deletion options (one day after creation, upon access by a data user) are alternatives, as indicated by “OR” logic operator 510 in FIG. 5, such that data is deleted whichever is the first to occur. Other, and additional, deletion options may be enabled. In alternate embodiments a logic function between multiple deletion options may be controlled, such that by way of example and not limitation such “OR” logic operator 510 may be an AND function, a NOR function, or such other logic operation as selected from a pulldown menu.

As shown in FIG. 5, anonymizing data, as indicated by “Anonymize Data?” option display 512 and corresponding “Yes” and “No” soft buttons 514, 516, respectively, may include replacing identification information (identifying either a user or a user's wearable device 202) that may be included with personal health parameter data as stored in wearable database 220 with a randomly generated number to prevent anyone from associating exchanged personal health parameter data with a particular user. In alternate embodiments, such data may be anonymized by simply deleting whatever ID data may be stored therewith. In alternate embodiments, these different methodologies for anonymizing data are presented to a user for selection. Other anonymizing options may be enabled. The data encryption function, as indicated by “Encrypt Data?” option display 518 and corresponding “Yes” and “No” soft buttons 520, 524, respectively, may be any sort of encryption, such as a WP2 layer or elliptical curve cryptography, that disallows transmission of personal health parameter data over an unsecure network. In alternate embodiments other security protocols may be invoked and applied to personal health parameter data, such as a digital rights management (DRM) security containers. In alternate embodiments, these different methodologies for data encryption (or, more broadly, for securing data) may be presented to a user for selection, via a pulldown menu or otherwise. Flag data GUI 234 also includes “Save Flags” soft button 528 that allows a user to save these security settings in wearable database 220 such that, for each health parameter type, such settings are stored, along with other data sharing settings, in the same relational table rows as (or in other association with) corresponding personal health parameter data to which they pertain. Button 528 also closes flag data GUI 234.

FIG. 6 is a block diagram of an exemplary wearable computing device 600 that may be used to implement wearable device 202 of FIG. 2. As shown, computing device 600 may include a memory interface 604, one or more data processors, image processors and/or central processing units 608, and a peripherals interface 612. Memory interface 604, one or more processors 608, and/or peripherals interface 612 may be separate components or may be integrated in one or more integrated circuits. The various components in computing device 600 may be coupled by one or more communication buses or signal lines.

Sensors, devices, and subsystems may be coupled to peripherals interface 612 to facilitate one or more functionalities. For example, a motion sensor 616, a light sensor 620, and a proximity sensor 624 may be coupled to peripherals interface 612 to facilitate orientation, lighting, and/or proximity functions. Other sensors 628 may also be connected to peripherals interface 612, such as a global navigation satellite system (GNSS) (e.g., GPS receiver), a temperature sensor, a biometric sensor, and/or one or more other sensing devices, to facilitate related functionalities.

A camera subsystem 632 (“C.S.S” in FIG. 6) and an optical sensor 636, e.g., a charged coupled device (CCD) or a complementary metal-oxide semiconductor (CMOS) optical sensor, may be utilized to facilitate camera functions, such as recording images and/or video. Camera subsystem 632 and optical sensor 636 may be used to collect images of a user to be used during authentication of a user, e.g., by performing facial recognition analysis.

Communication functions may be facilitated through one or more wireless communication subsystems 640 (“W.C.S.S.” in FIG. 6), which may include radio frequency receivers and transmitters and/or optical (e.g., infrared) receivers and transmitters. The specific design and implementation of communication subsystem 640 may depend on the communication network(s) over which computing device 600 is intended to operate. For example, computing device 600 may include communication subsystems 640 designed to operate over a GSM network, a GPRS network, an EDGE network, a Wi-Fi® or WiMax® (registered trademarks of the WiFi Alliance), and BLUETOOTH® (registered trademark of Bluetooth SIG, Inc.). In particular, wireless communication subsystems 640 may include hosting protocols such that one or more devices 600 may be configured as a base station for other wireless devices.

An audio subsystem 644 may be coupled to a speaker 648 and a microphone 652 to facilitate voice-enabled functions, such as speaker recognition, voice replication, digital recording, and/or telephony functions. Audio subsystem 644 may be configured to facilitate processing voice commands, voice-printing, and voice authentication.

I/O subsystem 656 may include a touch-surface controller 660 and/or other input controller(s) 664. Touch-surface controller 660 may be coupled to a touch surface 668. Touch surface 668 and touch-surface controller 660 may, for example, detect contact and movement or a lack thereof using one or more of any of a plurality of touch sensitivity technologies, including but not limited to capacitive, resistive, infrared, and/or surface acoustic wave technologies, optionally as well as other proximity sensor arrays and/or other elements for determining one or more points of contact with touch surface 668.

Other input controller(s) 664 may be coupled to other input/control devices 672, such as one or more buttons, rocker switches, thumb-wheel, infrared port, USB port, and/or a pointer device such as a stylus. One or more related buttons or other controls (not shown) may include one or more sets of up/down buttons for volume and/or amplitude control of speaker 648 and/or microphone 652. Using the same or similar buttons or other controls, a user may activate a voice control, or voice command, module that enables the user to speak commands into microphone to cause device 600 to execute the spoken command A user may customize functionality of one or more buttons or other controls. Touch surface 668 may, for example, also be used to implement virtual or soft buttons and/or a keyboard.

In some implementations, computing device 600 may present recorded audio and/or video files, such as MP3, AAC, and/or MPEG files. In some implementations, computing device 600 may include the functionality of an MP3 player, such as an iPod™. Computing device 600 may, therefore, include a 36-pin connector that is compatible with related iPod™ hardware. Other input/output and control devices may also be used.

As shown, memory interface 604 may be coupled to one or more types of memory 676. Memory 676 may include high-speed random access memory and/or non-volatile memory, such as one or more magnetic disk storage devices, one or more optical storage devices, and/or flash memory (e.g., NAND, NOR). Memory 676 may store an operating system 680, such as Darwin™ RTXC, LINUX, UNIX, OS X™, WINDOWS™, and/or an embedded operating system such as VxWorks. Operating system 680 may include instructions for handling basic system services and/or for performing hardware dependent tasks. In some implementations, operating system 680 may comprise a kernel (e.g., UNIX kernel). Further, in some implementations, operating system 680 may include instructions for performing voice authentication.

Memory 676 may also store communication instructions 682 to facilitate communicating with one or more additional devices, one or more computers, and/or one or more servers. Additionally or alternatively, memory 676 may include: graphical user interface instructions 684 to facilitate graphic user interface processing; sensor processing instructions 686 to facilitate sensor-related processing and functions; phone instructions 688 to facilitate phone-related processes and functions; electronic messaging instructions 690 to facilitate electronic-messaging related processes and functions; web browsing instructions 692 to facilitate web browsing-related processes and functions; media processing instructions 694 to facilitate media processing-related processes and functions; GNSS/Navigation instructions 696 to facilitate GNSS and navigation-related processes and instructions; and/or camera instructions 697 to facilitate camera-related processes and functions. Memory 676 may store other software instructions 698 to facilitate other processes and functions. For example, other software instructions 698 may include instructions for counting steps a user takes when device 600 is worn.

Memory 676 may also store other software instructions (not shown), such as web video instructions to facilitate web video-related processes and functions and/or web shopping instructions to facilitate web shopping-related processes and functions. In some implementations, media processing instructions 694 may be divided into audio processing instructions and video processing instructions to facilitate audio processing-related processes and functions and video processing-related processes and functions, respectively. An activation record and International Mobile Equipment Identity (IMEI) 699 or similar hardware identifier may also be stored in memory 676.

Each of the above identified instructions and applications may correspond to a set of instructions for performing one or more functions described herein. These instructions need not necessarily be implemented as separate software programs, procedures, or modules. Memory 676 may include additional instructions or fewer instructions. Further, various functions of computing device 600 may be implemented in hardware and/or in software, including in one or more signal processing and/or application specific integrated circuits.

FIG. 7 illustrates an exemplary screenshot 700 of data analysis GUI 236 of base software 224 on wearable device 202 of FIG. 2. In this screenshot, a third-party data requester 704 (in this case, “Big Data Company”) has submitted a request for a user's personal health parameter data for analysis, here health parameter types “Activity Data” 708 and “Heart Rate Data” 712. Data analysis GUI 236 allows a user to review and change data user settings and incentive settings (“rules”), and security settings (flags), for each requested data type via corresponding “Rules and Flags” soft buttons 716, 720 associated with requested health parameter types 708, 712, respectively. Consequently, a user may make any desired modifications to corresponding rules and flags before accepting (or denying) a request for data using “Yes” or “No” soft buttons 724 and 728, respectively, associated with a “Accept Request?” display option 732. In this manner, a user can specify rules (as described above with reference to FIG. 4) and flags (as described above with reference to FIG. 5) prior to any data being sent to a third-party requester. If a user selects “Yes” soft button 724, data exchange software 226 will be enabled by base software 224 to cause wearable device 202 to send personal health parameter data associated with such requested health parameter type to a data user, subject to data user settings permitting such access, and subject to security settings, applicable to such personal health parameter data. In the example shown in FIG. 7, an incentive offered by Big Data Company to receive activity data and heart rate data is to perform a data analysis on received data. This incentive offer is made through data exchange GUI 238 for acceptance by a user, as will be described with reference to FIG. 8. In order to accept this incentive offer, a user sets data user settings of rules GUI 232 of FIG. 4 to receive requests from “Big Data Companies,” and sets incentive settings of rules GUI 232 to accept incentives for “Data Analysis.” Data display areas 736, 740 provide a display of transmitted personal health parameter data corresponding to requested health parameter types 708, 712 (in this case, as graphs of activity and heart rate versus time), respectively. Data analysis display areas 744, 748, disposed beneath each of data display areas 736, 740 respectively, display data analyses from such data user corresponding to such shared personal health parameter data. Before selecting “Yes” soft button 724, the display region occupied by display areas 736, 740, 744, 748 may be blank or compressed, among other things. In alternate embodiments, prior to selection of “Yes” soft button 724 only data displays 736, 740 may be active. Data analysis GUI 236 also includes a “See more” soft button 752 that allows a user to view additional data and/or analysis information for requested health parameter types when activated.

FIG. 8 illustrates an exemplary screenshot 800 of data exchange GUI 238 of base software 224 on wearable device 202 of FIG. 2. In this screenshot, a third-party data user 804 (in this case, “Gym”) is requesting a user's personal health parameter data of a given health parameter type, here “Temperature Data” 808. Similarly to data analysis GUI 236 of FIG. 7, data exchange GUI 238 allows a user to review and change rules and flags for each requested heath parameter types via a corresponding “Rules and Flags” soft button 812. Consequently, a user can make any desired modifications to corresponding rules and flags before accepting (or denying) requests for data using “Yes” or “No” soft buttons 816 and 820, respectively, associated with a “Accept Request?” display option 824. In this manner, a user may control rules and flags prior to any personal health parameter data being sent to a third party data user. In the example shown in FIG. 8, an incentive offered by Gym to receive such temperature data is to offer a token 828 for a free drink (“smoothie”), redeemable at its facility. This incentive is indicated in a display region 832. To accept this incentive, a user sets data user settings of GUI 232 of FIG. 4 to receive requests from “Gym,” and sets incentive settings to accept “Tokens.” If a user selects “Yes” soft button 816, base software 224 will cause data exchange software 226 to send a user's personal health parameter data associated with requested health parameter type 808, along with any set flags (as described above with reference to FIG. 5) and in accordance with any set rules (as described above with reference to FIG. 4). Display region 832 will display token 828 after a user has already selected “Yes” soft button 816 to transmit data to such third-party requester. Before selecting “Yes” soft button 816, display region 832 may be blank, compressed, or may display an indicator or teaser for the incentive, among other things. In alternate embodiments, token 828 (or any other indicated incentive) may be presented in half-tones or in some other way that differentiates an offered incentive from an accepted incentive. In other alternate embodiments, a display of an accepted incentive may include additional information that a display of an offered incentive lacked. For example, with reference to the display of token 828 in FIG. 8, a display of such token prior to acceptance may not include bar code 836, and a corresponding display of such token as accepted may include bar code 836. In this example, data exchange GUI 238 also includes a “Save Token” soft button 840 that allows a user to save an incentive (such as token 828) for later retrieval and/or use.

In an alternate embodiment, in addition to display area 832 displaying token 828 or some other incentive, a “statement of use” from a requesting data user may also appear in display area 832. Around the world, legal standards are emerging pertaining to data privacy of personally identifying (or other personally sensitive) data. At least some of these privacy standards require data users to indicate the identity of a data user, what data will be retained by such data user, and for what purpose such retained data will be used by such data user. Some of these standards also require data providers to specifically indicate a willingness to provide requested data under such terms. In embodiments shown in FIGS. 7 and 8, the identity of a data user is explicitly provided (at 704, 804, respectively), and an identification of health parameter types requested is also explicitly provided (at 708, 712, 808, respectively). In this alternate embodiment, display area 832 would also include a statement from a requesting data user stating the purposes for which such requested data will be used. In alternate embodiments other related information may be included, such as whether a data user reserves the right to transfer such data to other data users. With these three pieces of information, in the event such emerging data privacy standards may be applicable to health parameter types and personal health parameter data described herein, this alternate embodiment permits users to indicate acceptance in a way that may comply with such standards.

In some embodiments, data users may provide dialogs (e.g., pop-up windows, GUIs) that may solicit feedback from a person wearing wearable device. Data users may use these dialogs to explicitly state all the uses they intend to make of the health parameter data, e.g., with a selectable option (e.g., a check box) next to each intended use. A user could select those uses that the user would prefer his or her health parameter data not be used (or to be used, as the case may be). In this manner, a wearer of wearable device 202 may opt in or opt out of their personal data being used for various purposes proposed by data users. In some embodiments, data users could configure such dialogs to provide priorities to their intended uses. For example, some intended uses may be deemed “must haves,” whereas other intended uses may be deemed “like to have.” In various embodiments, health parameter data may be transmitted only if one or more “must have” intended uses are permitted by the wearer of wearable device 202.

Persons of skill in the art will note that in the examples described above with reference to FIGS. 7 and 8, users receive and specifically respond to requests from data users for access to personal health parameter data of a given health parameter type, for all requests other than for health parameter types that are “locked” as shown in FIGS. 3 and 4. However, it is to be understood that in alternate embodiments, a user may preset so-called “default” data sharing settings of FIGS. 4 and 5 such that such requests are received and authorized automatically by base software 224. In such embodiments, users may associate incentives they would accept with data users they would accept, prior to receipt of offers from data users. By way of example and not limitation, with reference to FIG. 4, in such alternate embodiments rules GUI 232 may enable a user to indicate, for a given health parameter type, a willingness to accept “Token” incentives for any amount, above a specified amount, and/or for a specified amount for a particular type of good or service, and to specify such offers will be automatically accepted from “Restaurants” and “Gyms,” including (by way of example and not limitation) specific restaurants/gyms, a chain or otherwise related restaurants/gyms, or all restaurants/gyms. In these embodiments data exchange software 226 may automatically reject all other requests based on token incentives. Similarly, users may specify that they will only accept “Data Analytics” incentives from “Big Data Companies” for selected health parameter types, including (by way of example and not limitation) specific companies, a set of related companies, or all data analytic companies. In these embodiments data exchange software 226 may automatically reject all other requests based on data analytics incentives. As such, incentives may be offered and accepted without further user intervention. In yet other alternate embodiments, a hybrid approach may be used, by which users may set rules GUI 232 to automatically accept tokens (or other preselected incentives) above a certain value from a given data user or group of related data users, and to follow the processes described above with reference to FIGS. 7 and 8 for all other requests based on tokens or other specified incentives, rather than automatically rejecting them. In some embodiments, a data user may provide a dialog that a wearer of wearable device 202 may interact with (e.g., when the wearable device 202 is first purchased) to alter one or more sharing settings associated with that particular data user.

In some embodiments, sharing settings may be “learned” over time. For example, suppose a wearer of wearable device 202 repeatedly accepts offers to share data in exchange for incentives from a particular data user. If the wearer accepts enough offers, and especially if the wearer never turns that data user down, then the sharing settings may be updated to automatically accept future offers from that data user without user intervention (or at the very least, make it easier for the user to accept such offers by way of a more conspicuous GUI). Additionally or alternatively, if the user tends to reject all offers for a first incentive but accept all offers for a second incentive, then future offers for the first incentive may be rejected automatically, and/or future offers for the second incentive may be accepted automatically (or at the very least, make it easier for the user to accept such offers by way of a more conspicuous GUI).

In some embodiments, one or more machine learning classifiers may be trained to determine whether a given inventive offer should be accepted. For example, training examples may be provided in the form of instances labeled as positive examples, e.g., where users accepted offers, and as negative examples, e.g., where users rejected offers. These training examples may take the form of vectors of “features” associated with each instance. Various features may be included in the training example vectors, including but not limited to one or more attributes of the user's preferences, one or more attributes of the user, one or more attributes of the data user seeking health parameter data, one or more attributes of a context in which the offer was made, one or more attributes of the health parameter type or data being sought, one or more attributes of the incentive being offered (e.g., token versus data analysis, value of token, etc.), and so forth.

In yet other alternate embodiments, base software 224 may enable data users to increase their incentive offers. Pursuant to the process as described above with reference to FIGS. 7 and 8, if a given incentive is rejected, a data user has an ability to restart such process by offering a different, or more valuable, incentive. In other words, in such alternate embodiments incentive offers are not static. For example, a user may be offered a first incentive in exchange for particular health parameter data. Should the user reject the offer, in some cases the user may be presented with another offer with an incentive perceived to be more valuable. This may occur immediately after the user rejects the first offer or later when another opportunity arises to solicit health parameter data from the user. In some embodiments, when selecting alternative incentives to offer a user that has rejected an incentive, a data user may be given limited access to incentive that user (or users in general) have previously accepted for the desired health parameter data.

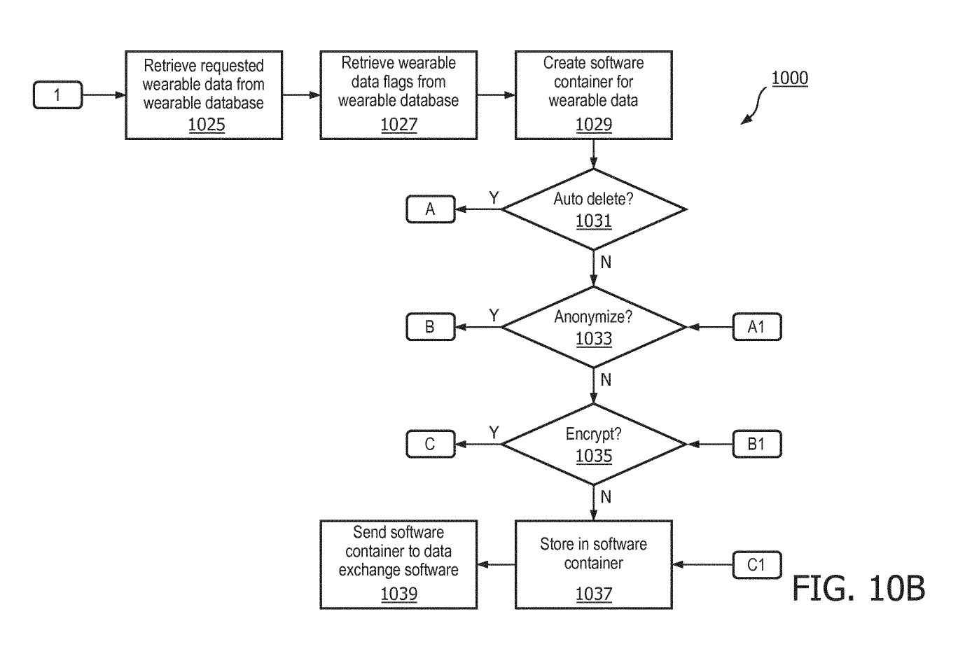

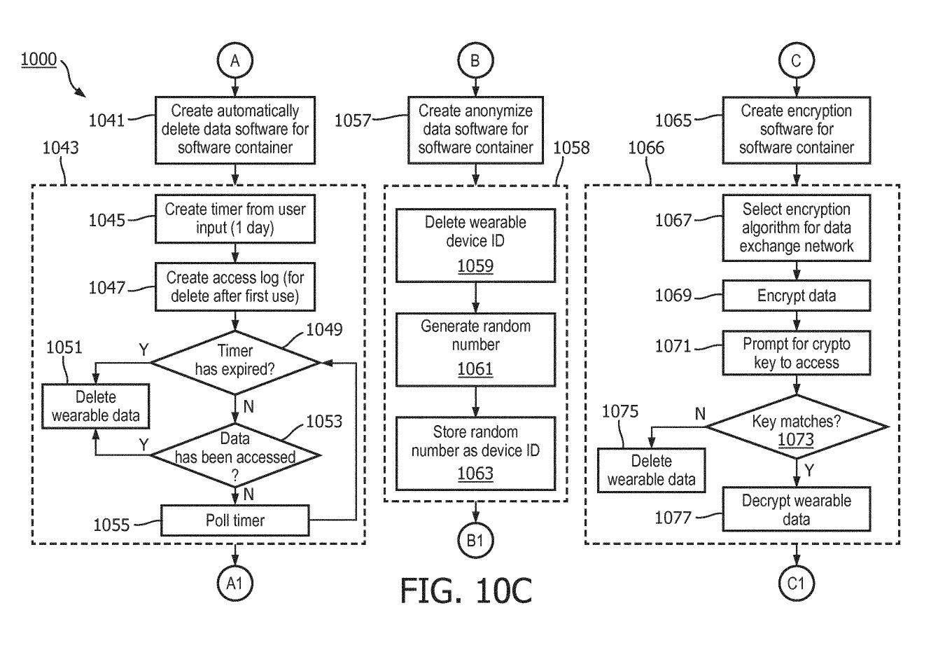

FIG. 9 illustrates an exemplary method 900 that base software 224 causes wearable device 202 to perform. As described above with reference to FIG. 2, in alternate embodiments some or all of these method steps may be conducted by software on user device 202. In this example, at step 905, base software 224 polls wearable sensors 218 to obtain personal health parameter data sensed by sensors 218. At step 910, base software 224 causes wearable device 202 to store such data in wearable database 220, along with an indication of a health parameter type to which such data pertains. At step 915, base software 224 causes wearable device 202 to display usage GUI 230 at display 216, enabling a user to view such data and prevent access by data users as described with reference to FIG. 3. If a user activates “Rules” soft button 316 of usage GUI 230, at step 920 base software 224 causes wearable device 202 to display rules GUI 232 (as described with reference to FIG. 4) to user at display 216, enabling a user to set data sharing settings including data user settings and incentive settings. If a user activates “Flags” soft button 320 data when interacting with device 202 via usage GUI 230, at step 925 base software 224 causes wearable device 202 to display flag data GUI 234 (as described with reference to FIG. 5) to a user at display 216, enabling a user to set data sharing settings including security settings. At step 930, base software 224 causes wearable device 202 to store data rules and data flags set in accordance with FIGS. 4 and 5, respectively, in wearable database 220. At step 935, wearable device 202 receives a request from a data user for receipt of personal health parameter information, and base software 224 prompts data exchange software 226 to carry out a data exchange routine described in more detail below with reference to FIG. 10A. At step 940, if a third party requests flagged data, base software 224 prompts data flagging software 228 to carry out a data security routine as described in more detail below with reference to FIGS. 10B to 10C. At step 945, base software 224 causes wearable device 202 to display at display 216 one or both of data analysis GUI 236 (as described with reference to FIG. 7) and data exchange GUI 238 (as described with reference to FIG. 8), to the extent applicable. Method 900 may then loop back to polling wearable sensors 218 for wearable sensor data, at step 905.

FIG. 10A illustrates a portion of exemplary method 1000 that data exchange software 226 may cause wearable device 202 to perform, and FIGS. 10B through 10C illustrate other respective portions of exemplary method 1000 that data flagging software 228 may prompt wearable device 202 to perform (or in some cases, enable for subsequent execution). As described above with reference to FIG. 2, in alternate embodiments some or all of these method steps may be conducted by software on user device 204. With reference to FIG. 10A, at step 1003 wearable device 202 receives a request for data exchange from data exchange network 206. At step 1005, data exchange software 226 causes wearable device 202 to search wearable database 220 for stored data user settings applicable to a requesting data user, and for stored health parameter types that are the same as the requested health parameter type. At step 1007, data exchange software 226 causes wearable device 202 to read such stored data user setting to determine whether or not a user may have disabled any potential transmission of data for a given health parameter type as described above with reference to FIGS. 3 and 4. If so, at step 1009, wearable device 202 denies such request and the process ends. If data access is permitted, at step 1011 data exchange software 226 (or, alternatively, base software 224) causes wearable device 202 to display data exchange GUI 238 at display 216. At step 1013, data exchange software 226 receives a user input via data exchange GUI 238 indicating whether or not a user accepts or rejects such data access request. If a user rejects such request, wearable device 202 denies such request at step 1009, and the process ends. If a user accepts such request, at step 1015 data exchange software 226 queries wearable database 220 to determine if any security settings apply to such requested data. If so, at step 1017 data exchange software 226 (or, alternatively, base software 224) invokes data flagging software 228, as indicated at process endpoint pathway 1 (which begins a portion of process 1000 that commences at step 1025 in FIG. 10B). If requested data is not flagged, at step 1019 data exchange software 226 causes wearable device 202 to send requested personal health parameter data to data exchange network 206 via communications transceiver 214 and cloud or internet 208. Note that this step 1019 may also be initiated by process endpoint pathway 2 from the portion of process 1000 as described with reference to FIG. 10B, as will be described in more detail below. After sending requested personal health parameter data to data exchange network 206, wearable device 202 receives an accepted incentive from data exchange network 206 via cloud or internet 208 and communications transceiver 214. At step 1021, data exchange software 226 causes such received incentive to be stored in third party database 222, and at step 1023 data exchange software 226 prompts base software 224 to cause wearable device 202 to display such incentive via data exchange GUI 238 or data analysis GUI 236, as applicable, at display 216, and to respond to any subsequent user commands entered via an applicable one of such GUIs. The process then ends.

FIG. 10B illustrates a portion of exemplary method 1000 that may be performed by data flagging software 228 on wearable device 202. The method begins at process endpoint pathway 1 from the process shown in FIG. 10A. At step 1025, data flagging software 228 causes wearable device 202 to read requested personal health parameter data from wearable database 220. At step 1027, data flagging software 228 causes wearable device 202 to read security settings associated with such pulled data. At step 1029, if any flags are read, data flagging software 228 then creates a “software container” for such wearable data. In some embodiments, a “software container” may refer to an entire runtime environment, including one or more applications, plus all code (e.g., libraries, binaries, configuration files) on that the application needs to run, bundled into a package. By containerizing the application platform and all dependencies, differences in computing environments between wearable device 202 and other environments such as data exchange network 206 or user device 204 may be abstracted away. In some embodiments, a software container may include the application and dependencies as noted above, bundled within a virtual machine (e.g., that includes an OS) that can be exchanged between computing environments. Note that a software container may not be created at all if security settings associated with such personal health parameter data do not include any activated flags. In that case, such personal health parameter data would be communicated in any conventional form, such as one or more data packets linked to one another by control headers to define an integrated data packet

The next three steps depend on security settings that a user inputted via flag data GUI 234 that are applicable to such pulled data. Each of such steps is associated with at least one pathway, as discussed in more detail with reference to FIG. 10C, which adds additional software to such defined software container as discussed above. The first test, at step 1031, is to determine if a user has selected a flag to automatically delete such related personal health parameter data. If yes, data flagging software 228 proceeds to process endpoint pathway A, which (as described below with reference to FIG. 10C) generates data deletion control code in accordance with flags for automatic data deletion as shown in FIG. 5, and provides such generated code as input A1 in FIG. 10B for addition to such software container as described below with reference to step 1037. If no, data flagging software 228 proceeds to step 1033, which is a second test to determine if a user has selected to have such personal health parameter data anonymized. If yes, data flagging software 228 proceeds to process endpoint pathway B, which (as described below with reference to FIG. 10C) creates code to anonymize such data to be transferred in accordance with data anonymize flags as shown in FIG. 5, and provides this resultant as input B1 in FIG. 10B for addition to such software container as described below with reference to step 1037. If no, data flagging software 228 proceeds to step 1035, which is a third test to determine if a user has selected to encrypt such personal health parameter data. If yes, data flagging software 228 proceeds to process endpoint pathway C, which (as described below with reference to FIG. 10C) creates code to encrypt such data to be transferred in accordance with encryption flags as shown in FIG. 5, and provides such generated code as input C1 in FIG. 10B for addition to such software container as described below with reference to step 1037. It is to be understood that while in FIG. 10B three pathways are shown, in alternate embodiments different or additional pathways may be included, corresponding to different or additional security settings as described above.

At step 1037 data flagging software 228 causes wearable device 202 to store such software container in wearable database 220, including all such generated code for automatic deletion (if applicable), code to anonymize such data (if applicable), and code to encrypt such data (if applicable). At step 1039, data flagging software 228 then causes data exchange software 226 to read such resultant software container from wearable database 220, execute some or all activated software contained in the software container, and then follow process endpoint pathway 2 to step 1019 of FIG. 10A. As previously stated, if no security settings or flags are enabled, at step 1039 personal health parameter data may be provided without being associated with or in a software container.

FIG. 10C is a continuation of exemplary method 1000 that data flagging software 228 may perform, and illustrates three pathways A-C discussed above associated with steps 1031-1035 as described above with respect to FIG. 10B. Starting with pathway A, at step 1041 data flagging software 228 activates “automatically delete data” software instructions, the nature and operations of which are described with reference to sub-process steps 1045-1055 indicated by dotted line box 1043 along pathway A. As will be readily apparent to a person of skill in the art, data flagging software 228 does not necessarily “create” any code for any of the operations described with respect to FIG. 10C. Rather, such code may already exist as inactive code modules within data flagging software 228 itself. As data flags are read, such inactive code from data flagging software 228 is customized in accordance with the data flags, and may be added to applicable secure containers as described below. In the description below this process is referred to as “activation.”

For the specific flags shown in “Automatically Delete” options of FIG. 5, at step 1045 data flagging software 228 activates “timer code” (not shown) that includes a timer or clock, code that initiates such timer (in this case, as of when data is transmitted to a data user), code to terminate such timer (in this case, twenty four hours after initiation), code to query timer status, and code to delete such transferred data once such timer terminates. At step 1047 data flagging software 228 also activates “access code” (not shown) that includes an access log (a subfile that embodies a counter that increments whenever an associated data file is read from memory), code to query the status of such access log, and code to delete such transferred personal health parameter data when this access log increments. After such personal heath parameter data is transferred to a data user, at step 1049 this timer code queries such timer to determine whether or not it has expired. If so, at step 1051 the timer code deletes such transferred data. If not, at step 1053 the access code determines whether or not such data has been accessed, and if so at step 1051 this access code deletes such transferred data. If the timer code indicates that such timer has not expired, and the access code indicates that such data user has not accessed such data, at step 1055 the timer code returns to step 1049 and again determines whether or not such timer has expired. After creation of this described timer code and access code, data flagging software 228 follows process endpoint pathway A1 back to FIG. 10B.

For pathway B of FIG. 10C, at step 1057 data flagging software 228 activates anonymizing data software code for insertion to the software container, by invoking process 1058 (indicated by the dashed box) in accordance with status of a anonymize data flag as shown in FIG. 5. At step 1059, data flagging software 228 activates “ID deletion code” that causes deletion of ID information that may be included in personal health parameter data. At step 1061, data flagging software 228 activates “random number generation” code (not shown) that create a random number having a number of digits that is the same as whatever ID information was deleted from such data to be transferred. At step 1063, the ID deletion code may store such random number in place of such deleted ID information. As previously discussed, in alternate embodiments this process may simply delete wearable device ID. Data flagging software 228 then follows process endpoint pathway B1 back to FIG. 10B.

For pathway C of FIG. 10C, at step 1065 data flagging software 228 activates code to encrypt personal health parameter data to be transferred and generate crypto keys relating to such encrypted data, by invoking process 1066 (indicated by the dashed box). This encryption process, as well as other processes that may apply one or more protocols to secure data during transmission, is invoked as a function of the status of the encryption flags of FIG. 5. At step 1067, data flagging software 228 selects an encryption algorithm that will be applied to data to be transmitted as determined by such encryption flags, to activate “encrypting code” (not shown) that encrypts such data. As discussed previously, flag data GUI 234 may present a user a choice of encryption methodologies from which to select, including by way of example and not limitation WPA2 or elliptical curve cryptography. At step 1069, when data is transmitted, it is encrypted by such encrypting code.

In addition to activating encrypting code, data flagging software 228 also activates “encryption control code” (not shown) that enables the steps set forth below that may be performed at data exchange network 206 and/or at a device operated by a data user. After such personal health parameter data is transferred, when encrypted data is accessed to be read by a data user, at step 1071 such encryption control code prompts a data user to apply a crypto key to access such encrypted data. A crypto key is known in the art as a key associated with decryption of data using an encryption algorithm. In encryption algorithms such as RSA, this prompt would include a public key, to which a data user would need to apply a private key separately provided by wearable device 202. At step 1073, such encryption control code determines if a crypto key provided by such data user is accurate. If not, at step 1075 such encryption control code deletes such encrypted data. If so, at step 1077 such encryption control code decrypts encrypted data, to allow a data user to view an unencrypted representation of transmitted personal health parameter data. The encrypting code and encryption control code as described above will then be provided by data flagging software 228, by following process endpoint pathway C1 back to FIG. 10B.

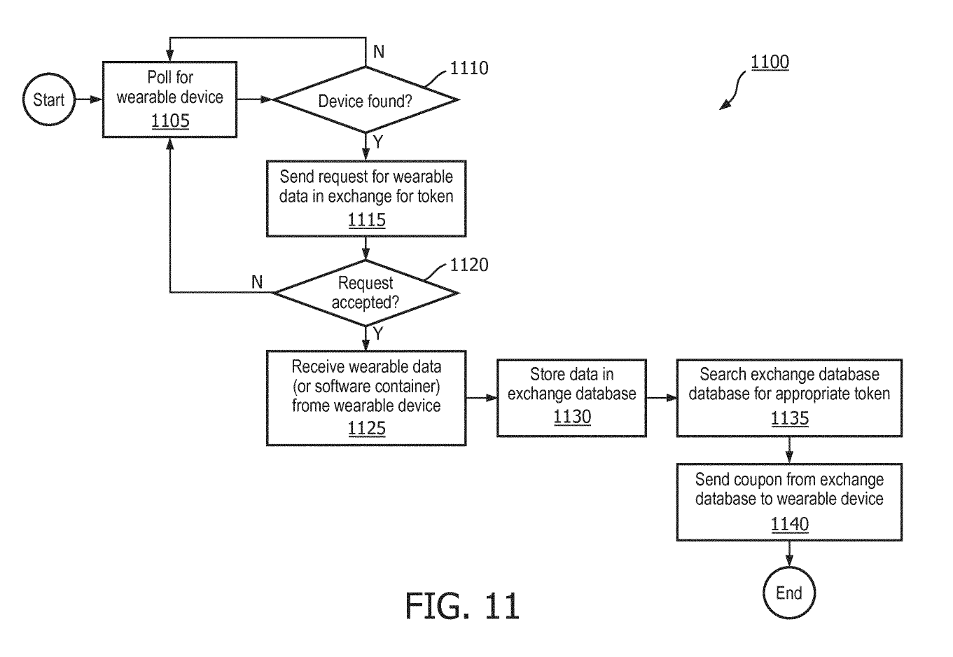

FIG. 11 illustrates an exemplary method 1100 that can be performed by token software 242 running on data exchange network 206 of FIG. 2. At step 1105, token software 242 may cause data exchange network 206 to poll for wearable devices 202. This could be done, for example, by geolocation or connectivity to a network via a BLUETOOTH or WI-FI connection, among others. At step 1110, token software 242 causes data exchange network 206 to determine if a wearable device is found. If a wearable device is not found, token software 242 causes data exchange network 206 to continue polling for a wearable device 202. At step 1115, if such polling results in a wearable device being found, token software 242 causes data exchange network 206 to send a request to a detected wearable device 202, with an offer to provide a token in exchange for personal health parameter data of a particular health parameter type. At step 1120 token software 242 causes data exchange network 206 to determine whether a user has indicated (via their associated wearable device 202) acceptance of an access request, as described in more detail above with respect to FIGS. 7-9. If a request is not accepted, polling step 1105 is reinitiated. If a request has been accepted, at step 1125 token software 242 causes data exchange network 206 to receive requested data (in the form of a software container, if one or more flags are associated with such requested personal health parameter data as described above with reference to FIGS. 10B-10C) from wearable device 202. At step 1130, token software 242 may cause data exchange network 206 to store transmitted data in exchange database 246. In some instances, token software 242 may execute activated code that is contained in the software container, e.g., to anonymize and/or encrypt health parameter data if not already done at wearable device 202. At step 1135, token software 242 may cause data exchange network 206 to search exchange database 246 for an appropriate token. An “appropriate token” may be any token that meets the parameters of a token that was offered to and accepted by a user. In alternate embodiments, this step may be eliminated at this juncture, by searching for tokens in exchange database 246 and sending a representation of such token to a user in a form that cannot be exercised prior to acceptance by such user. Upon finding an appropriate token, at step 1140 token software 242 causes data exchange network 206 to transmit such token from exchange database 246 via cloud or internet 208 and transceiver 214 to display 216 of data exchange GUI 238, and the process ends.

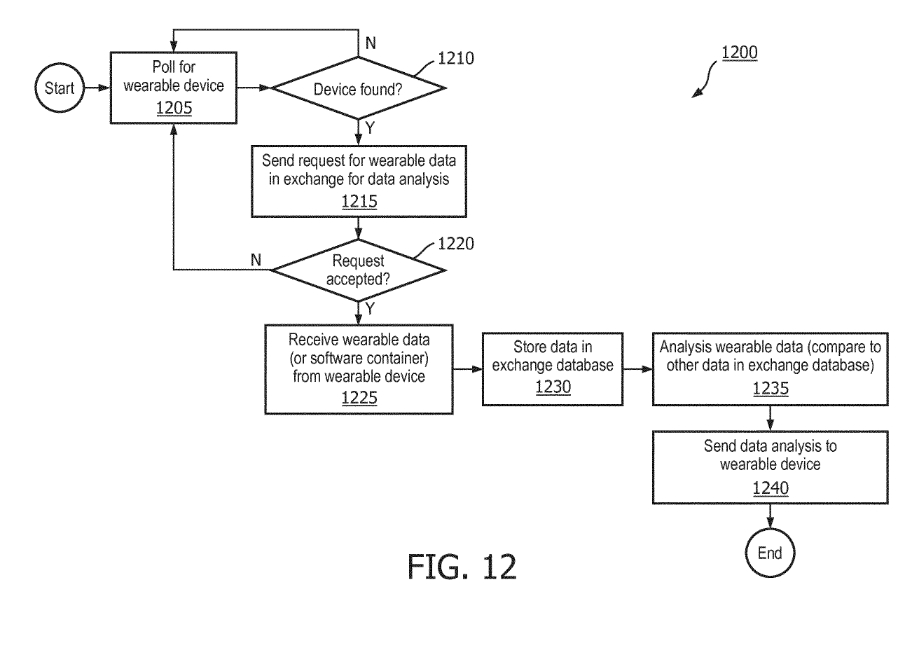

FIG. 12 illustrates an exemplary method 1200 that can be performed by data analysis software 244 running on data exchange network 206 of FIG. 2. At step 1205, data analysis software 244 may cause data exchange network 206 to poll for wearable devices 202. This could be done, for example, by geolocation or connectivity to a network via a BLUETOOTH or WI-FI connection, among others. At step 1210, data analysis software 244 causes data exchange network 206 to determine if a wearable device is found. If a wearable device is not found, data analysis software 244 causes data exchange network 206 to continue polling for a wearable device 202. At step 1215, if polling results in a wearable device being found, data analysis software 244 causes data exchange network 206 to send a request to detected wearable device 202, with an offer to provide a token in exchange for personal health parameter data of a particular health parameter type. At step 1220, data analysis software 244 causes data exchange network 206 to determine whether a user has indicated (via their associated wearable device 202) acceptance of a request, as described in more detail above with respect to FIGS. 7-9. If the request is not accepted, polling step 1205 is reinitiated. If a request has been accepted, at step 1225 data analysis software 244 causes data exchange network 206 to receive the requested data (in the form of a software container, if one or more flags are associated with such requested personal health parameter data as described above with reference to FIGS. 10B-10C) from wearable device 202. At step 1230, data analysis software 244 may cause data exchange network 206 to store transmitted data in exchange database 246. In some instances, data analysis software 244 may execute activated code that is contained in the software container, e.g., to anonymize and/or encrypt health parameter data if not already done at wearable device 202. At step 1235, data analysis software 244 causes data exchange network 206 to carry out one or more analyses on transferred personal health parameter data pursuant to one or more analysis algorithms (not shown) applicable to analysis offered to and accepted by a user, and to store resultant analyses in exchange database 246. At step 1240, data analysis software 244 causes data exchange network 206 to transmit such data analyses from exchange database 246 via cloud or internet 208 and transceiver 214 to display 216 of data analysis GUI 236, and the process ends.

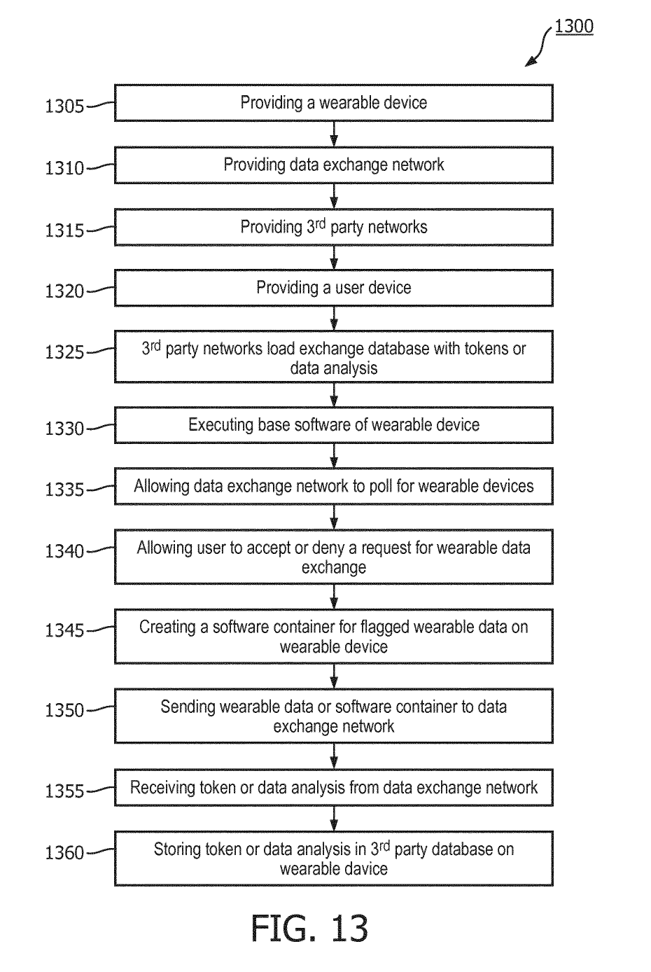

FIG. 13 illustrates a method 1300 of utilizing data exchange system 200 of FIG. 2. It is to be understood that depicted background steps 1305-1320, which include providing wearable device 202, data exchange network 206, third party networks 248-254, and a user device 204, respectively, collectively establish a hardware and software environment within which this exemplary method 1300 may be practiced, as set forth below. It is to be understood that background steps 1305-1220 do not form part of the actual method conducted using data exchange system 200 of FIG. 2.

At step 1325, token software 242 and/or data analysis software 244 prompt third party networks 248-254 to load exchange database 246 with tokens or data analysis, respectively, to be offered to users. At step 1330, base software 224 of wearable device 202 is executed, to enable users to set data sharing settings by health parameter type. At step 1335, data exchange network 206 polls for wearable devices 202. At step 1340, data exchange software 226 enables a user to accept or deny a request for personal health parameter data, via data exchange GUI 238 or data analysis GUI 236 as applicable, and by setting or resetting data sharing settings as applicable. At step 1345, data flagging software 228 prompts wearable device 202 to create a software container based on security settings from flag data GUI 234. At step 1350, personal health parameter data, with or without instantiation in a software container (as applicable), is transmitted from device 202 via communications transceiver 214 and cloud or internet 208 to data exchange network 206. At step 1355, a corresponding incentive (such as a token or data analysis) is received by wearable device 202, and in step 1360 such received token, data analysis, or other incentive is stored in third party database 222 on wearable device 202. Those skilled in the art will readily appreciate that the method of FIG. 13 is merely exemplary, and many other methods that include subsets of depicted steps of this method may be devised in accordance with changes to and/or alternative uses of data exchange system 200 of FIG. 2.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 14 shows a diagrammatic representation of one embodiment of a computing device in the exemplary form of a computer system 1400 within which a set of instructions for causing a control system, such as the data exchange system of FIG. 2, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1400 includes a processor 1404 and a memory 1408 that communicate with each other, and with other components, via a bus 1412. Bus 1412 may include any of several types of bus structures including, but not limited to, a memory bus, a memory controller, a peripheral bus, a local bus, and any combinations thereof, using any of a variety of bus architectures.

Memory 1408 may include various components (e.g., machine-readable media) including, but not limited to, a random access memory component, a read only component, and any combinations thereof. In one example, a basic input/output system 1416 (BIOS), including basic routines that help to transfer information between elements within computer system 1400, such as during start-up, may be stored in memory 1408. Memory 1408 may also include (e.g., stored on one or more machine-readable media) instructions (e.g., software) 1420 embodying any one or more of the aspects and/or methodologies of the present disclosure. In another example, memory 1408 may further include any number of program modules including, but not limited to, an operating system, one or more application programs, other program modules, program data, and any combinations thereof.

Computer system 1400 may also include a storage device 1424. Examples of a storage device (e.g., storage device 1424) include, but are not limited to, a hard disk drive, a magnetic disk drive, an optical disc drive in combination with an optical medium, a solid-state memory device, and any combinations thereof. Storage device 1424 may be connected to bus 1412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1424 (or one or more components thereof) may be removably interfaced with computer system 1400 (e.g., via an external port connector (not shown)). Particularly, storage device 1424 and an associated machine-readable medium 1428 may provide nonvolatile and/or volatile storage of machine-readable instructions, data structures, program modules, and/or other data for computer system 1400. In one example, software 1420 may reside, completely or partially, within machine-readable medium 1428. In another example, software 1420 may reside, completely or partially, within processor 1404.

Computer system 1400 may also include an input device 1432. In one example, a user of computer system 1400 may enter commands and/or other information into computer system 1400 via input device 1432. Examples of an input device 1432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1432 may be interfaced to bus 1412 via any of a variety of interfaces (not shown) including, but not limited to, a serial interface, a parallel interface, a game port, a USB interface, a FIREWIRE interface, a direct interface to bus 1412, and any combinations thereof. Input device 1432 may include a touch screen interface that may be a part of or separate from display 1436, discussed further below. Input device 1432 may be utilized as a user selection device for selecting one or more graphical representations in a graphical interface as described above.

A user may also input commands and/or other information to computer system 1400 via storage device 1424 (e.g., a removable disk drive, a flash drive, etc.) and/or network interface device 1440. A network interface device, such as network interface device 1440, may be utilized for connecting computer system 1400 to one or more of a variety of networks, such as network 1444, and one or more remote devices 1448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1444, may employ a wired and/or a wireless mode of communication. In general, any network topology may be used. Information (e.g., data, software 1420, etc.) may be communicated to and/or from computer system 1400 via network interface device 1440.

Computer system 1400 may further include a video display adapter 1452 for communicating a displayable image to a display device, such as display device 1436. Examples of a display device include, but are not limited to, a liquid crystal display (LCD), a cathode ray tube (CRT), a plasma display, a light emitting diode (LED) display, and any combinations thereof. Display adapter 1452 and display device 1436 may be utilized in combination with processor 1404 to provide graphical representations of aspects of the present disclosure. In addition to a display device, computer system 1400 may include one or more other peripheral output devices including, but not limited to, an audio speaker, a printer, and any combinations thereof. Such peripheral output devices may be connected to bus 1412 via a peripheral interface 1456. Examples of a peripheral interface include, but are not limited to, a serial port, a USB connection, a FIREWIRE connection, a parallel connection, and any combinations thereof.

The foregoing has been a detailed description of various illustrative embodiments. Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A method of providing an incentive to a user of a wearable device, the method comprising:
providing, by one or more processors of a wearable device worn by a user, a user interface operable by the user;
receiving, at the user interface, a data sharing setting for a health parameter type detected by one or more sensors operably coupled with the one or more processors;
transmitting, by the one or more processors over one or more communication links, to one or more remote computing devices accessible by a third party data user pursuant to said data sharing setting, personal health parameter data of said health parameter type detected by the one or more sensors;
receiving, by the one or more processors over the one or more communication links, in exchange for the shared personal health parameter data, data indicative of an incentive; and
outputting, by the one or more processors using an output device, a representation of the incentive to the user.

2. The method of providing an incentive of claim 1, wherein said data sharing setting comprises an authorization to provide the personal health parameter data to one or more recipients.

3. The method of providing an incentive of claim 2, wherein said data sharing setting comprises an authorization to provide the personal health parameter data to a plurality of recipients sharing a common characteristic and wherein said common characteristic comprises business type.

4. The method of providing an incentive of claim 1, wherein said data sharing setting further comprises an authorization to receive incentive offers for the personal health parameter data from one or more requesters, and the method further comprises receiving, by the one or more processors over the one or more communication links, an incentive offer for the personal health parameter data.

5. The method of providing an incentive of claim 4, wherein said data sharing setting comprises an authorization to receive incentive offers sharing a common characteristic, and wherein said common characteristic comprises type of incentive.

6. The method of providing an incentive of claim 1, wherein said data sharing setting further comprises an option to select a length of time the personal health parameter data is retained at a remote device after said sharing step.

7. The method of providing an incentive of claim 1, wherein said data sharing setting further comprises an option to anonymize the shared personal health parameter data.

8. The method of providing an incentive of claim 1, wherein said data sharing setting further comprises an option to encrypt the shared personal health parameter data.

9. A computing device comprising a processor and memory, and a plurality of computer instructions stored in the memory which when executed by the processor cause the computing device to perform the following operations for sharing personal health parameter data detected by one or more sensors of a wearable device in exchange for an offered incentive:
storing, in the memory, the personal health parameter data detected by one or more sensors of the wearable device;
receiving an offer from an identified data user that requests personal health parameter data in exchange for an incentive;
receiving one or more data user settings indicating data users authorized to receive the personal health parameter data;
receiving one or more incentive settings indicating incentives that a user will accept to share the personal health parameter data;
storing, in the memory, said data user settings and said incentive settings in association with the personal health parameter data to which they pertain;
comparing said data user to said stored data user settings, and comparing said offered incentive to said stored incentive settings, for the personal health parameter data to which such offer pertains; and
selectively transmitting the requested personal health parameter data to said data user based on a result of the comparing.

10. The computing device of claim 11, wherein the method carried out by the computing device further comprises:
receiving one or more security settings applicable to the personal health parameter data should it be transmitted to a data user; and
prior to said step of transmitting the requested personal health parameter data to said data user, applying said security settings to the personal health parameter data to be transmitted.

11. A wearable device, comprising:
at least one sensor for detecting, from a user wearing the wearable device, personal health parameter data of at least one health parameter type;
one or more processors; and
a memory operably coupled with the one or more processors and storing a plurality of computer instructions which when executed by the one or more processors, cause the one or more processors to carry out the following operations for sharing said personal health parameter data:
storing, in said memory, said personal health parameter data detected by said sensor,
providing a user interface operable by the user;
receiving, at the user interface, one or more data user settings identifying one or more data users authorized to receive said personal health parameter data,
receiving, at the user interface, one or more incentive settings indicating one or more incentives that the user will accept in exchange for sharing said personal health parameter data,
storing, in said memory, said data user settings and said incentive settings in association with said personal health parameter data to which they pertain, and
comparing a requesting data user to said stored data user settings, and an offered incentive to said stored incentive settings, for requested personal health parameter data; and
a communications transceiver operably coupled with the one or more processors to selectively transmit said requested personal health parameter data to said requesting data user based on a result of the comparing.

12. The wearable device of claim 11, wherein at least one of said data user settings and said incentive settings are set by health parameter type of said personal health parameter data.

13. The wearable device of claim 12, wherein said method carried out by said wearable device further comprises the steps of:
receiving, at the user interface, one or more security settings applicable to said personal health parameter data; and
prior to said communication system transmitting said requested personal health parameter data to said data user, applying said security settings to said personal health parameter data to be transmitted.

14. The wearable device of claim 13, wherein said security settings comprise at least one of data retention settings, data anonymizing settings, and data encryption settings.

15. The wearable device of claim 14, wherein said security settings are set by health parameter type of said personal health parameter data.
